(19) United States
(12) Patent Application Publication
(10) Pub. No.: US 2014/0292864 A1
(43) Pub. Date: Oct. 2, 2014

(54) Ink Jet Recording Apparatus

(71) Applicant: Hitachi Industrial Equipment Systems Co., Ltd., Tokyo (JP)

(72) Inventors: Ryuta MOTOYANAGI, Tokyo (JP); Nobuhiro HARADA, Tokyo (JP); Hiroshi SASAKI, Tokyo (JP); Masahiko OGINO, Tokyo (JP)

(73) Assignee: Hitachi Industrial Equipment Systems Co., Ltd., Tokyo (JP)

(21) Appl. No.: 14/154,574

(22) Filed: Jan. 14, 2014

(30) Foreign Application Priority Data
Mar. 29, 2013 (JP) 2013-070973

(51) Int. Cl. B41J 2/045

(52) U.S. Cl. CPC B41J 2/04501
USPC 347/14

(57) ABSTRACT

An ink jet recording apparatus receives an output signal of a printing object detecting sensor, counts a pulse signal of an encoder based on a predetermined number of character scans, and controls the operation start of an ink curing device.

### BACKGROUND OF THE INVENTION

The present invention relates to an ink jet recording apparatus. JP-A-2000-327980 which is a background art of the present technical field discloses, “For example, although it is not shown in a drawing, after printing with a curable ink by the ink jet device shown FIG. 1, an exposure portion is provided to perform photo-curing of the curable ink. The exposure portion of the curable ink is not particularly limited but a variety of means can be adopted depending on usages. For example, it is preferable to irradiate ultraviolet light or visible light with a wavelength of 200-500 nm using a light source such as a high-pressure mercury lamp, a low-pressure mercury lamp, a metal halide lamp or an excimer lamp so that an exposure amount becomes 100 to 2000 mJ/cm². The irradiation to the curable ink can also be performed while scanning with a laser beam or convergent light obtained using a lens or a mirror.”

### SUMMARY OF THE INVENTION

A continuous type ink jet recording apparatus always ejects an ink continuously from a nozzle orifice. The ejected ink particles are recovered through an ink recovering mechanism called a gutter.

A factor to be taken into consideration for the control of the timing of ink curing includes a production line conveying speed of a conveyer for conveying a printing object. It is general that the ink jet recording apparatus prints a use-by date, a serial number, etc. on the printing object which are conveyed successively by the conveyor of a production line in a factory. The conveying speed is variable depending on production lines, and it is necessary to cure the ink printed on the printing object according to a change in conveying speed of the production line.

As a related art of the ink jet recording apparatus accompanying ink curing, there is for example a technology described in JP-A-2000-327980. A printed printing object is conveyed through the ink curing device to cure the ink. The ink curing device adopts various methods such as an ink curing method by heating and an ink curing method by light. The existing apparatus has an ink jet recording device and a UV ink curing device independently, and the UV ink curing device always irradiates constant light. Therefore, when the production line has a change in conveying speed, the light exposing time of the printed printing object is different. If the production line has a fast conveying speed, the time for irradiation to the printing object becomes short, and the ink curing time might become insufficient. It is because the light irradiation device has a fixed inside length where the printing object is conveyed. Therefore, since the time for irradiating light to the printing object depends on the conveying speed of the production line, it is necessary to control the light irradiation considering the production line conveying speed.

The conventional ink curing device must be used in the state that the power source is always activated because it does not control depending on the production line conveying speed, and the ink curing device increases its power consumption as a result. The ink curing time of the printing object is variable depending on the production line conveying speed. Therefore, the ink does not cure sufficiently because the ink curing time is excessively short.

The ink curing device also has a problem of power consumption because it always performs the ink curing operation. Since the ink jet recording device is disposed near the production line, the print head for ejecting the ink is positioned at a variety of positions of the production line shape. Therefore, it is occasionally difficult to dispose the ink curing device at a desired position.

The present invention aims to provide an ink jet recording apparatus that reduces power consumption and power consumption amount by performing ink curing for a necessary time by determining the timing of ink curing.

In order to solve the above subject, for example, a structure described in “What is claimed is” is adopted.

The present application includes a plurality of means for solving the above problem, and its one example is configured as, “An ink jet recording apparatus, including a nozzle for ejecting an ink toward a conveying track for a printing object, a charging electrode which is disposed to electrically charge ink particles by generating a charging field in a region where the ink ejected from the nozzle is separated to become the ink particles, deflection electrodes for deflecting the charged ink particles by generating a deflection electric field in a flying path for the ink particles, a deflection power source for applying a deflection voltage to the deflection electrode, a gutter for recovering the ink particles not used for printing, an ink curing portion for curing the ink, a rotary encoder for generating a pulse signal according to a moving speed of a production line, a printing object detecting sensor, and a control portion, wherein the control portion receives an output signal of the printing object detecting sensor, counts a pulse signal of the encoder based on a predetermined number of character scans, and controls the operation start of the ink curing portion.”

According to the present invention, there can be provided an ink jet recording apparatus of which power consumption and power consumption amount are reduced by designing an ink curing device to have a flexible shape, disposing it so as to comply with the shape of a production line and determining a timing for ink curing to perform ink curing for a necessary time.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the whole structure of an ink jet recording apparatus according to an embodiment of the present invention.

FIG. 2 is a schematic diagram showing a basic structure of printing by the ink jet recording apparatus according to the embodiment of the present invention.

FIG. 3 is a flow chart showing a light irradiation method in the embodiment of the present invention.

FIG. 4 is a diagram showing a light irradiation control function adjustment screen in the embodiment of the present invention.

FIG. 5 is a diagram showing that speed tracking ON was selected on a screen for selecting speed tracking ON or speed tracking OFF in the embodiment of the present invention.

FIG. 6 is a diagram showing a light irradiation timing setting screen on which light irradiation timing was set in the embodiment of the present invention.

FIG. 7 is a diagram showing the light irradiation timing setting screen on which a light irradiation timing value was input in the embodiment of the present invention.

FIG. 8 shows a screen for light irradiation time setting in the embodiment of the present invention.

FIG. 9 is a diagram showing the light irradiation time setting screen on which a light irradiation time value was input in the embodiment of the present invention.

FIG. 10 is a diagram showing the light irradiation time setting screen on which a light irradiation time value at a maximum conveying speed of a production line was input in the embodiment of the present invention.

FIG. 11 is a diagram showing the light irradiation time setting screen on which a value of the number of light irradiation units of a light irradiation portion was input in the embodiment of the present invention.

FIG. 12 is a diagram showing that speed tracking OFF was selected on the screen for selecting speed tracking ON or speed tracking OFF in the embodiment of the present invention.

FIG. 13 is a diagram showing the light irradiation timing setting screen on which light irradiation timing was set in the embodiment of the present invention.

FIG. 14 is a diagram showing the light irradiation time setting screen on which light irradiation time was set in the embodiment of the present invention.

FIG. 15 is a diagram showing the light irradiation timing setting screen on which a light irradiation timing value was input in the embodiment of the present invention.

FIG. 16 is a diagram showing the light irradiation time setting screen on which a light irradiation time value was input in the embodiment of the present invention.

FIG. 17 is a diagram showing the light irradiation time setting screen on which a value of light irradiation time at a maximum conveying speed of the production line was input in the embodiment of the present invention.

FIG. 18 is a diagram showing the light irradiation time setting screen on which a value of the number of the light irradiation units of the light irradiation portion of a light irradiation device was input in the embodiment of the present invention.

FIG. 19 is a diagram showing power consumption and power consumption amount of the light irradiation portion on an operation panel in the embodiment of the present invention.

FIG. 20 is a diagram showing a flexible structure of light irradiation units of the light irradiation portion of the light irradiation device and light irradiation to a printing object in the embodiment of the present invention.

FIG. 21 is a diagram showing setting along the production line shape and light irradiation based on the flexible structure of light irradiation units of the light irradiation portion of the light irradiation device in the embodiment of the present invention.

FIG. 22 is a diagram showing the light irradiation units of the light irradiation portion viewed from direction Z in the embodiment of the present invention.

FIG. 23 is a diagram showing the light irradiation units of the light irradiation portion viewed from direction Z in the embodiment of the present invention.

FIG. 24 is a diagram showing control of a light irradiation time in the embodiment of the present invention.

FIG. 25 is a diagram showing a split structure of the light irradiation portion of the light irradiation device in the embodiment of the present invention.

FIG. 26 is a diagram showing a timing chart at a high conveying speed with a speed tracking function ON in the embodiment of the present invention.

FIG. 27 is a diagram showing a timing chart at a constant conveying speed with a speed tracking function OFF in the embodiment of the present invention.

### DETAILED DESCRIPTION OF THE EMBODIMENT

The embodiment according to the present invention will be described below with reference to the drawings.

An ink jet recording apparatus 100 according to the embodiment of the present invention includes an ink jet recording device body including a print head portion 130 for printing, an ink circulating route of an ink feed pipe connected thereto, an ink container, a pump, etc. The print head portion is connected to the ink jet recording device body through a tube such that it can be placed at a position different from the ink jet recording device body.

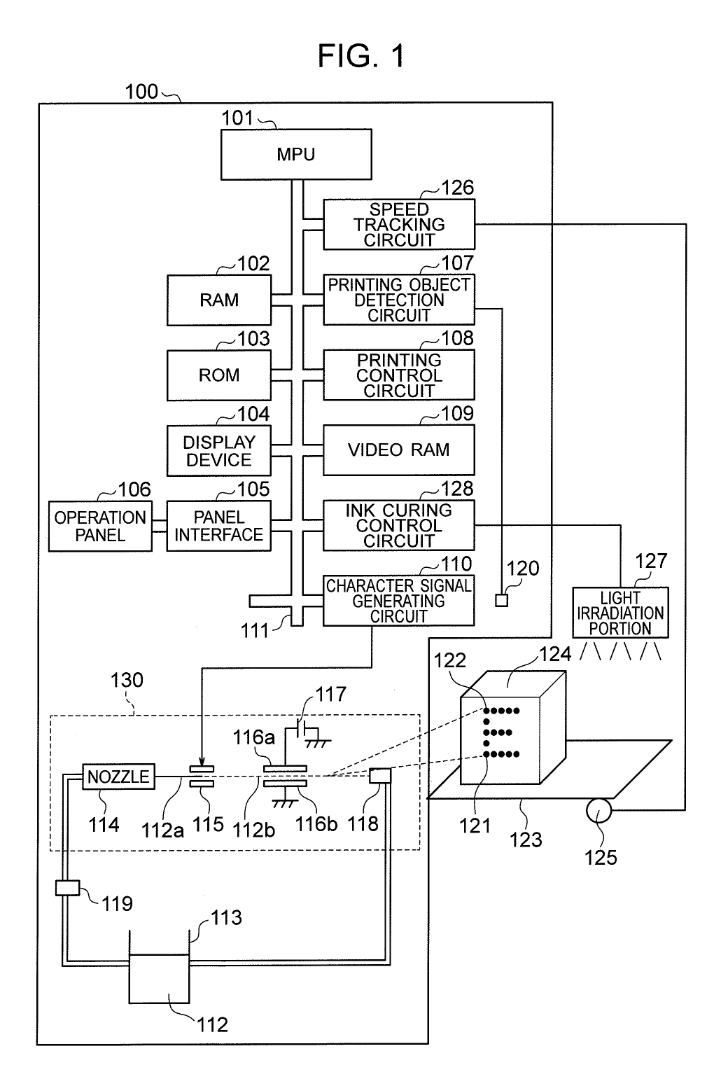

FIG. 1 is a functional block diagram of the ink jet recording apparatus showing an embodiment of the present invention.

In FIG. 1, an ink jet recording device is connected with an MPU (microprocessing unit) 101 for controlling the whole ink jet recording apparatus, a RAM (random access memory) 102 for temporarily recording data in the ink jet recording apparatus, a ROM (read only memory) 103 for previously recording a program and the like, a display device 104 for displaying printing contents and the like, a panel interface 105, an operation panel 106 for inputting predetermined values such as a printing font height and the like, a printing object detection circuit 107, a printing control circuit 108 for general control of printing by the ink jet recording apparatus 100, a video RAM 109 for storing video data which is charged to ink particles 112b, a character signal generating circuit 110 for generating a charging voltage used to electrically charge the ink particles 112b, a positive deflection electrode 116a, and a negative deflection electrode 116b through a bus line 111 for sending data, etc.

The print head portion 130 which is a printing mechanism has an ink 112, an ink container 113 for holding the ink 112, a nozzle 114 for ejecting the ink toward a conveying track of a printing object 124, a charging electrode 115 which is disposed to electrically charge the ink particles 112b by generating a charging field in a region where an ink (ink column) 112a, which is ejected from the nozzle 114, is separated to become the ink particles 112b, a deflection electrode 116 for deflecting the charged ink 112b by generating a deflection electric field in a flying path for the ink particles 112b, a deflection power source 117 for applying a deflection voltage 116 to the deflection electrode 116, a gutter 118 for recovering the ink particles 112b not used for printing, a feed pump 119 for supplying to the nozzle 114 by pumping up and pressurizing the ink 112 in the ink container 113, and a printing object detecting sensor 120 which reacts when the printing object 124 conveyed by a conveyor 123 reaches a printing region.

A rotary encoder 125 is also provided to generate a pulse signal depending on a moving speed (conveying speed) of the production line. The rotary encoder is not built in the ink jet recording device but disposed at the production line, and an existing one may be used for it. When a user prepares new one, various types of rotary encoders may be used. A signal generated from the rotary encoder is sent to the MPU 101 via a speed tracking circuit 126, calculated by the MPU 101, and used for speed tracking function. Numeral 127 is a light irradiation portion of the ink curing device of the present invention which is designed to cure the ink. The ink curing device is not built in the ink jet recording apparatus but disposed on the downstream side of the production line of the print head of the ink jet recording apparatus. The light irradiation portion 127 of the ink curing device is controlled via an ink curing control circuit 128.

Ink ejection and printing are described below. When information such as printing contents is input from the operation panel through the panel interface 105, the MPU 101 creates video data to be charged to the ink particles 112b according to print information by the program stored in the ROM 103, and stores in the video RAM 109 through the bus line 111. When the printing object is detected by the printing object detecting sensor 120, the MPU 101 receives a print starting command via the printing object detection circuit 107. The MPU 101 sends the video data stored in the video RAM 109 to the character signal generating circuit 110 through the bus line 111. The character signal generating circuit 110 changes the received video data to a charging signal. The printing control circuit 108 controls timing to send out the charging signal to the charging electrode 115 through the bus line 111.

Within the print head, the ink pressurized to a prescribed pressure is supplied to an ejection route. A piezoelectric vibrator is caused by voltage to oscillate within the print head to vibrate the ink to particulate it. The particulated ink 112b is ejected from the orifice portion. The particulated ink is electrically charged by applying the charging voltage to the charging electrode by the charging signal with its timing of transmission to the charging electrode 115 controlled, further deflected by the deflection electrode 116 so as to be ejected outside, and flied to the printing object to adhere thereto, thereby printing is performed.

When a charging voltage is applied by the charging electrode 115, the ink particles 112b having a large electric charge amount have a large deflected amount, and the particles having a small electric charge amount have a small deflected amount. The ink particles 112b having a small electric charge amount is deflected slightly by the deflection electrode 116 and used to print the lower half of the print character. The ink particles 112b having a large electric charge amount is deflected largely by the deflection electrode 116 and used to print the upper half of the print character. The ink not used for printing, namely, the ink particles 112b not electrically charged are recovered by the gutter 118 and supplied again to the print head by the pump 119. The ink jet recording device performs printing according to the above method.

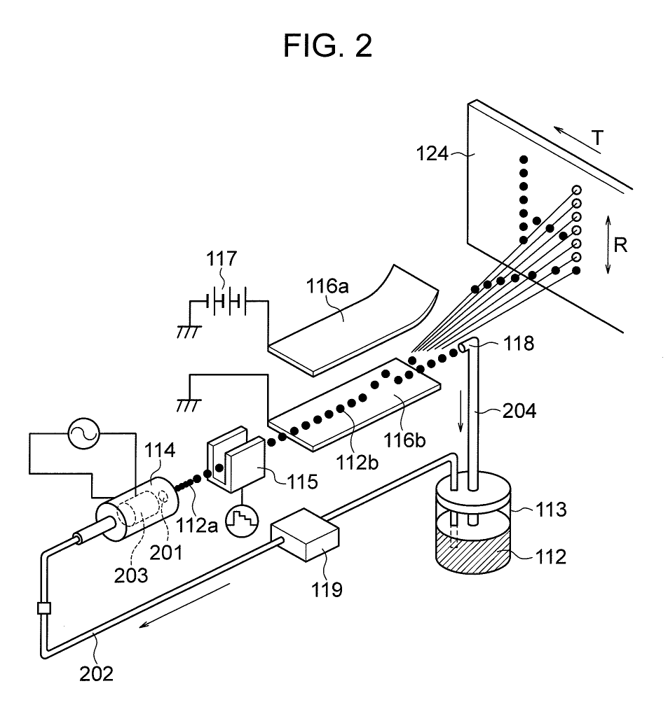

FIG. 2 is a schematic diagram showing a basic structure of the print head. As shown in FIG. 2, the print head has the nozzle 114 for ejecting the ink column 112a. The nozzle 114 is connected with an ink supply passage 202 for supplying the ink in an ink container, namely the ink container 113, disposed within the device body, and the ink supply passage 202 is provided with the feed pump 119. The ink in the ink container 113 is pressurized by sucking by the feed pump 119 to become the ink column 112a and ejected from an ejection port 201 of the nozzle 114.

The nozzle 114 is provided with an electrostrictive element 203, the ink is vibrated by the electrostrictive element 203 at a prescribed frequency, and the ink column 112a ejected from the nozzle 114 is particulated. Thus, the number of the ink particles 112b to be generated is determined by a frequency of excitation voltage applied to the electrostrictive element 203, and has the same frequency as the frequency of the excitation voltage. The charging electrode 115 is disposed in front of the nozzle 114 and electrically charges the ink particles 112b when a voltage having a magnitude corresponding to print information is applied to the charging electrode 115.

The positive deflection electrode 116a and the negative deflection electrode 116b are arranged in front of the charging electrode 115. The ink particles 112b electrically charged by a charging electrode 207 are deflected upon receiving a force proportional to the electric charge amount while they are flying through the electric field between the positive deflection electrode 116a and the negative deflection electrode 116b, and flown toward the printing object 124 to impact on the printing object 124. At that time, the ink particles 112b are caused to change the impact positions in a deflection direction indicated by arrow R depending on the electric charge amount. The ink particles 112b can also be impacted in a direction perpendicular to the deflection direction by moving the printing object 124 in a conveying direction T perpendicular to the deflection direction R by the belt conveyor 123, thereby printing characters and graphics on the printing object with a plurality of impact particles. Numerals 121 and 122 in FIG. 1 each denote printing dots at the lower part and printing dots at the upper part formed on the printing object 124.

To recover the ink particles 112b not used for printing, the gutter 118 is provided in the print head to face the ejection port 201 of the nozzle 114, and the ink particles 112b which are linearly flown without being deflected between the positive deflection electrode 116a and the negative deflection electrode 116b are caught by the gutter 118. The caught ink particles 112b are recovered into the ink container 113 through an ink recovery passage 204.

Description is made below on an overview of a system for keeping the light irradiation time constant even if there is a change in light irradiation timing and production line conveying speed of the ink curing device, which is a printing system of the ink jet recording apparatus according to the present invention, and a mechanism that can set the ink curing device at a desired position along the shape of the production line.

The present invention becomes possible to set a desired light irradiation timing and a desired light irradiation time for the printing object by inputting a target light irradiation time on the screen of the operation panel. To determine the desired light irradiation time, conditions related to the light irradiation time include an exciting frequency, the number of character rows, a font size, a line space, character width setting, a particle usage rate, the number of characters in the horizontal direction, a conveying speed, and print data.

A mechanism for controlling the light irradiation timing depending on a change in conveying speed is described below. To control the light irradiation timing, a printing object sensor and an encoder are used, and the light irradiation timing is controlled by automatic computation within the ink jet recording device.

To start lighting, the light irradiation timing is controlled by inputting an output signal of the printing object sensor to the ink jet recording device, and counting a pulse of the encoder. The encoder pulse indicates the number of character scans, and the light irradiation timing is determined according to the number of scan times input on the operation panel.

For a timing of light out, the number of print characters is computed within the ink jet recording apparatus to determine the number of print character scans. When the last scan of the input print characters is input, a timing when the printing is terminated is determined as a timing of light out.

An operation procedure of the light irradiation control function according to the present invention is described below in detail.

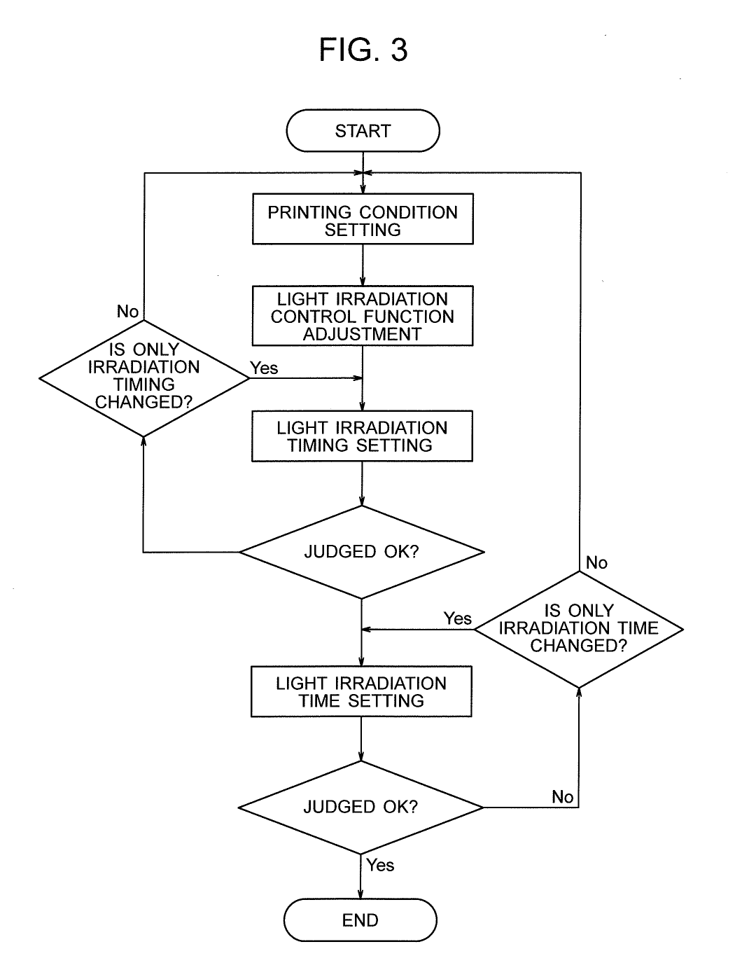

In the flow chart of FIG. 3, printing conditions are first set. After entering a light irradiation control function adjustment screen, a speed tracking function ON or a speed tracking function OFF is selected. When the speed tracking function ON is shown on the light irradiation timing setting screen, the number of scans is input. When the speed tracking function OFF is selected, a time is input. A light irradiation timing is set, and an execution key is selected. If it is feasible, the process of light irradiation timing setting is terminated, and the process proceeds to the light irradiation time setting screen. If it is infeasible to set the light irradiation timing value, “NG” is shown on the screen. If the irradiation timing only is changed, the screen resumes the light irradiation timing setting. If the change is not limited to the irradiation timing only, a printing condition setting screen comes next.

A light irradiation time is then input on the light irradiation time setting screen. It is determined if the light irradiation time is feasible depending on the number of light irradiation units of the light irradiation portion 127 of the ink curing device described later. Therefore, the value of a desired light irradiation time, the maximum conveying speed of the production line and the number of light irradiation units of the light irradiation portion 127 are input, and if it is feasible, the processes on the light irradiation timing and the light irradiation time function are terminated. The process enters a print mode, and printing is performed.

If the input value is infeasible when the light irradiation time is input, the screen shows guidance “NG” as a judged result. If the change is made to the light irradiation time only, the value of light irradiation time, the maximum conveying speed of the production line and the number of light irradiation units of the light irradiation portion are input again. Otherwise, the printing condition is set again, and the light irradiation timing is set again to enter the light irradiation time screen again to input the value.

Setting of the light irradiation timing and the light irradiation time on the operation panel screen is described below.

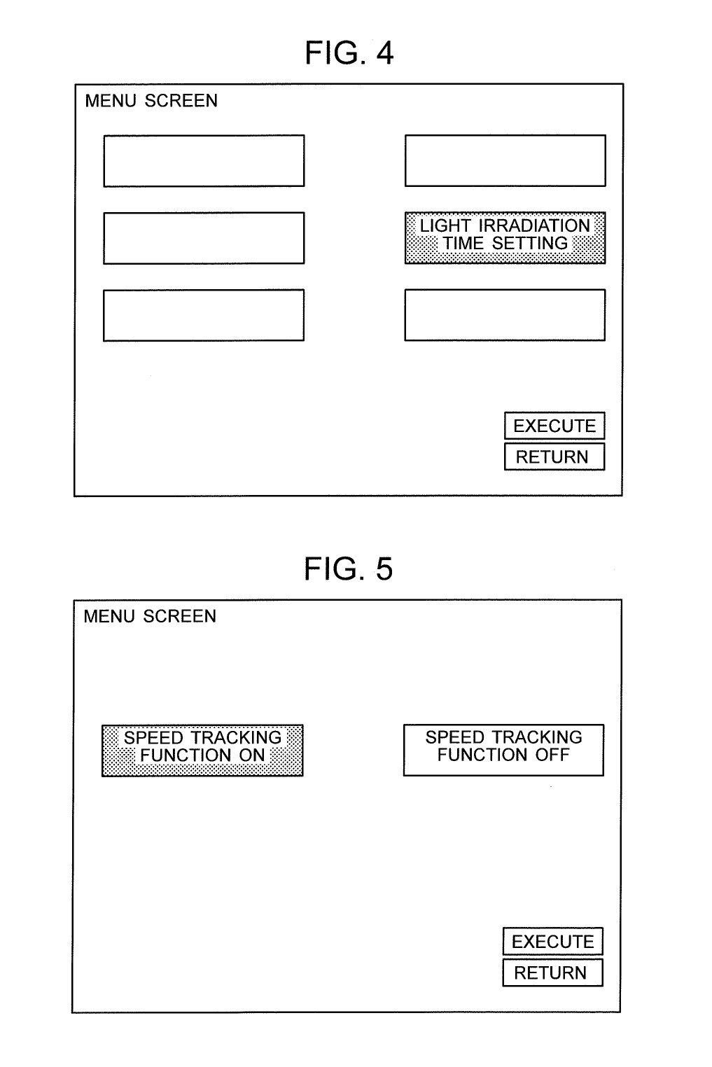

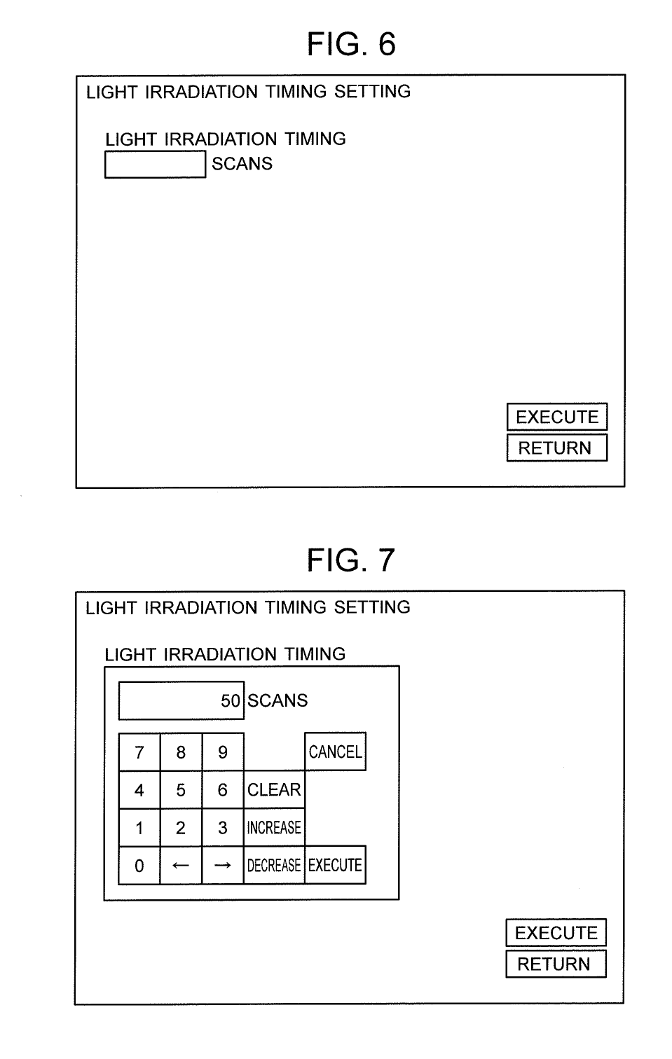

As shown in FIG. 4, adjustment of the light irradiation control function is selected from a menu screen, and the speed tracking function ON or the speed tracking function OFF is selected first. FIG. 5 shows that the speed tracking function ON was selected on the screen for selection of the speed tracking function ON or the speed tracking function OFF. The speed tracking function ON is described first. FIG. 6 shows a diagram of light irradiation timing. When a frame is selected, a ten-key portion is shown on “light irradiation timing” as shown in FIG. 7, and a desired light irradiation timing can be input by scanning The ten-key portion includes a cancellation key for cancelling an input numeric value, a clear key for clearing an input numeric value, an increase key for increasing an input numeric value, a decrease key for decreasing a numeric value, etc. in addition to the numeric keys. FIG. 7 shows that 50 scans is input for setting the light irradiation timing.

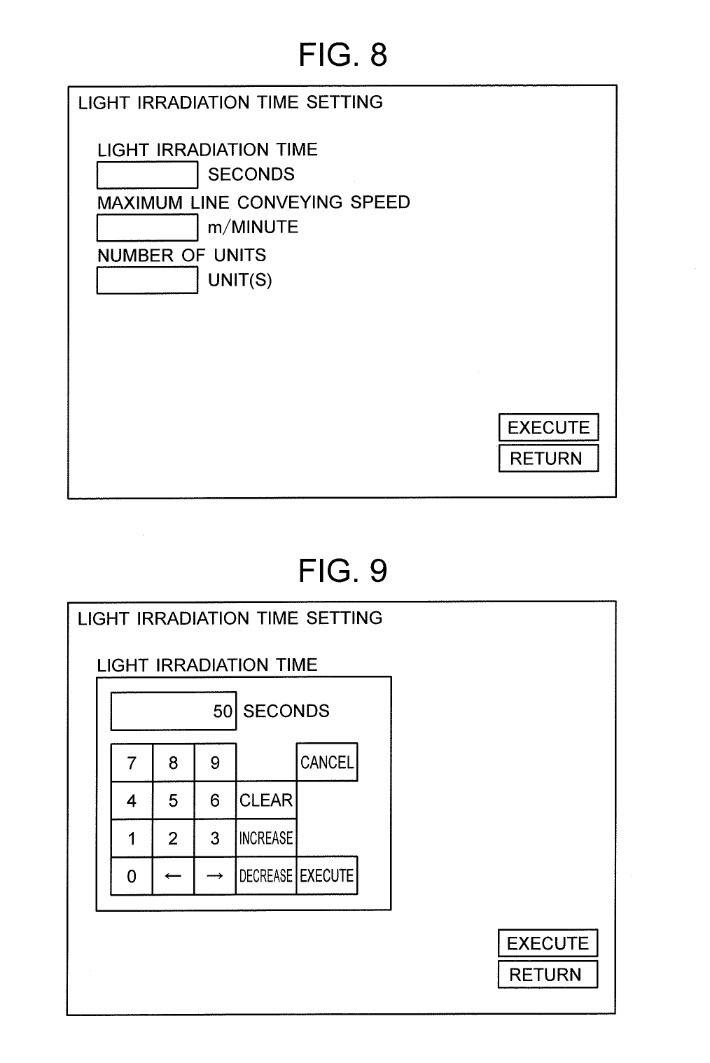

FIG. 8 shows a screen for setting of the light irradiation time. For example, when the light irradiation time of FIG. 8 is selected, the ten-key portion is shown on the “light irradiation time” as shown in FIG. 9, and a desired actual printing width value can be input. The ten-key portion also includes a cancellation key for cancelling an input numeric value, a clear key for clearing an input numeric value, an increase key for increasing an input numeric value, a decrease key for decreasing a numeric value, etc. in addition to the numeric keys. FIG. 9 shows that 50 seconds is input as a light irradiation time.

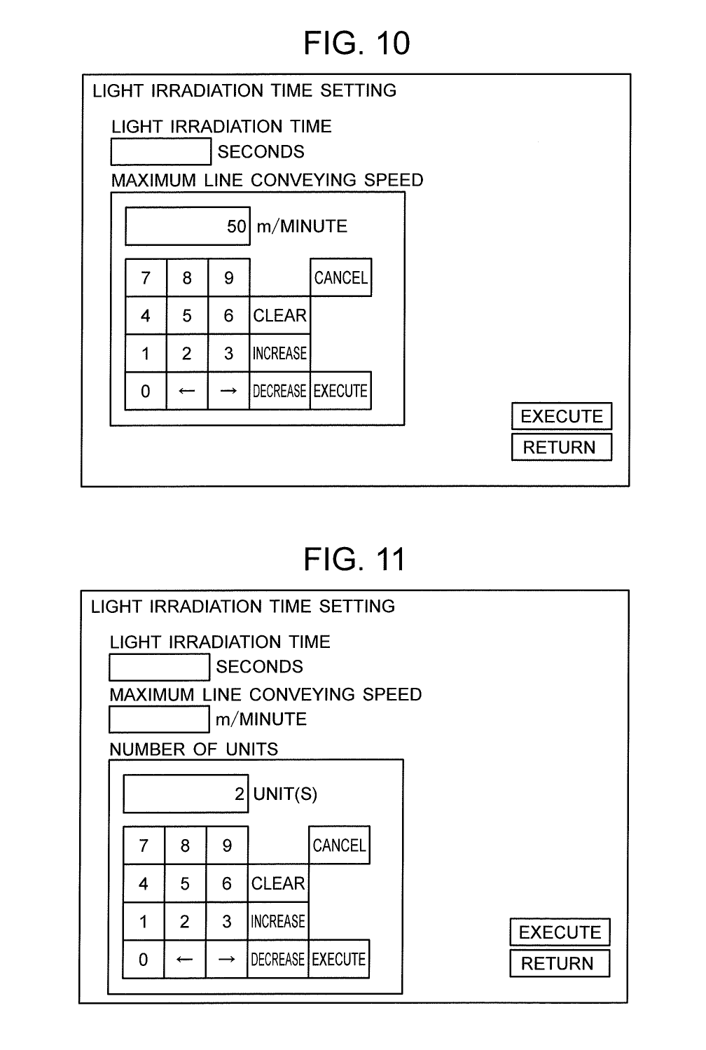

FIG. 10 shows a diagram that the maximum conveying speed of the production line is input. The maximum conveying speed of the production line can be input. The ten-key portion also includes a cancellation key for cancelling an input numeric value, a clear key for clearing an input numeric value, an increase key for increasing an input numeric value, a decrease key for decreasing a numeric value, etc. in addition to the numeric keys. FIG. 10 shows that 50 m/minute is input as the maximum conveying speed of the production line.

FIG. 11 shows a diagram that the number of the light irradiation units of the light irradiation portion having plural light irradiation units is input. That is, the number of the light irradiation units of the light irradiation portion can be input. The ten-key portion also includes a cancellation key for cancelling an input numeric value, a clear key for clearing an input numeric value, an increase key for increasing an input numeric value, a decrease key for decreasing a numeric value, etc. in addition to the numeric keys. FIG. 11 shows that two is input as the number of the light irradiation units of the light irradiation portion.

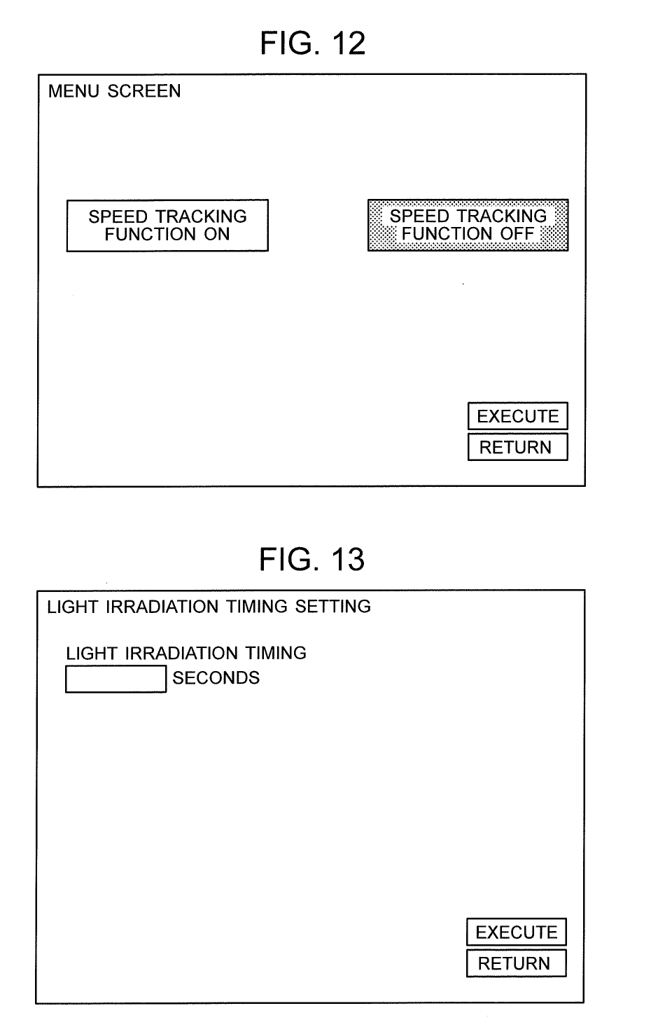

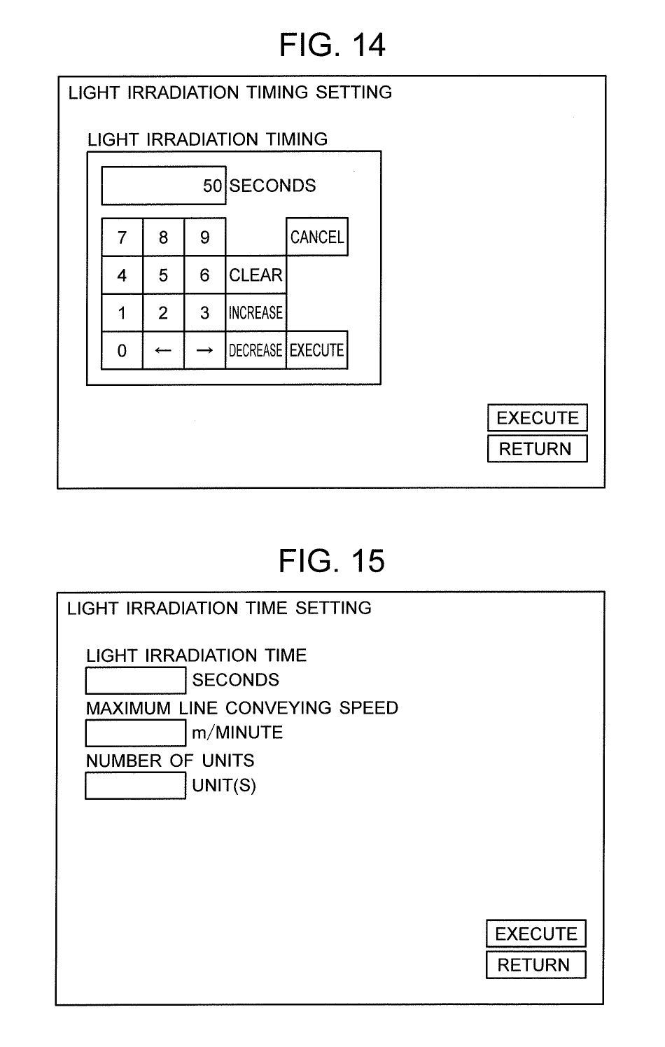

The speed tracking function OFF is described below. As shown in FIG. 12, the speed tracking function OFF is selected. FIG. 13 shows a diagram of light irradiation timing. As shown in FIG. 14, the ten-key portion is shown on the “light irradiation timing”, and a desired light irradiation timing can be input in seconds. The ten-key portion also includes a cancellation key for cancelling an input numeric value, a clear key for clearing an input numeric value, an increase key for increasing an input numeric value, a decrease key for decreasing a numeric value, etc. in addition to the numeric keys. FIG. 14 shows that 50 seconds is input for setting the light irradiation timing.

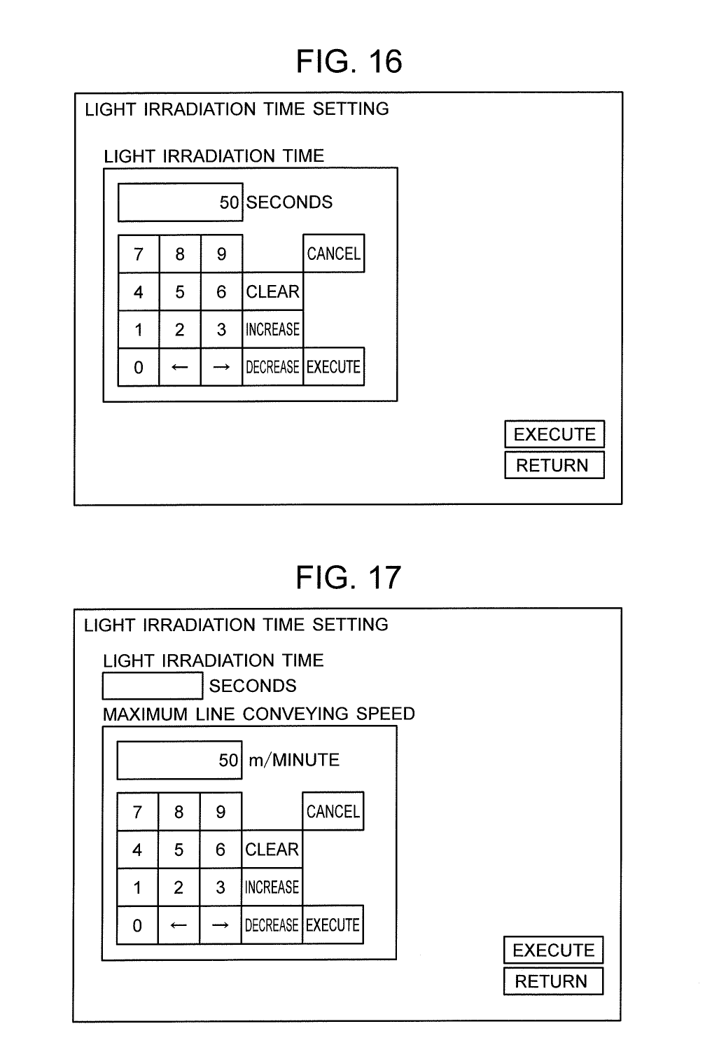

FIG. 15 shows a screen for setting the light irradiation time. As shown in FIG. 16, the ten-key portion is shown in the “light irradiation time”, and a desired actual printing width value can be input. The ten-key portion also includes a cancellation key for cancelling an input numeric value, a clear key for clearing an input numeric value, an increase key for increasing an input numeric value, a decrease key for decreasing a numeric value, etc. in addition to the numeric keys. FIG. 16 shows that 50 seconds is input as the light irradiation time.

FIG. 17 shows a diagram that the maximum conveying speed of the production line is input. The maximum conveying speed of the production line can be input. The ten-key portion also includes a cancellation key for cancelling an input numeric value, a clear key for clearing an input numeric value, an increase key for increasing an input numeric value, a decrease key for decreasing a numeric value, etc. in addition to the numeric keys. FIG. 17 shows that 50 m/minute is input as the maximum conveying speed of the production line.

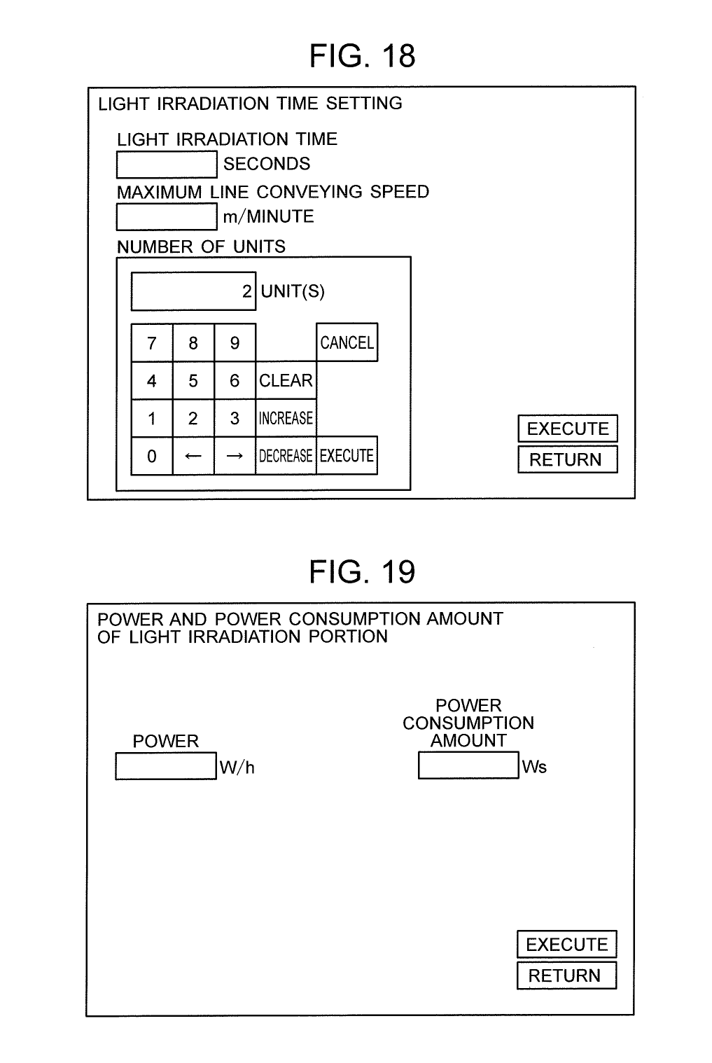

FIG. 18 shows a diagram that the number of the light irradiation units of the light irradiation portion having plural light irradiation units is input. The number of the light irradiation units of the light irradiation portion can be input. The ten-key portion also includes a cancellation key for cancelling an input numeric value, a clear key for clearing an input numeric value, an increase key for increasing an input numeric value, a decrease key for decreasing a numeric value, etc. in addition to the numeric keys. FIG. 18 shows that two is input as the number of light irradiation units of the light irradiation portion.

FIG. 19 shows a screen of the operation panel showing a power consumption (W/h) and a power consumption amount (Ws) of the ink curing device.

The structure of the ink curing device will be described. The light irradiation portion of the ink curing device has a structure in which a plurality of units are lined up, and the joint part between the units has a hinge structure and can be flexibly bent vertically and horizontally.

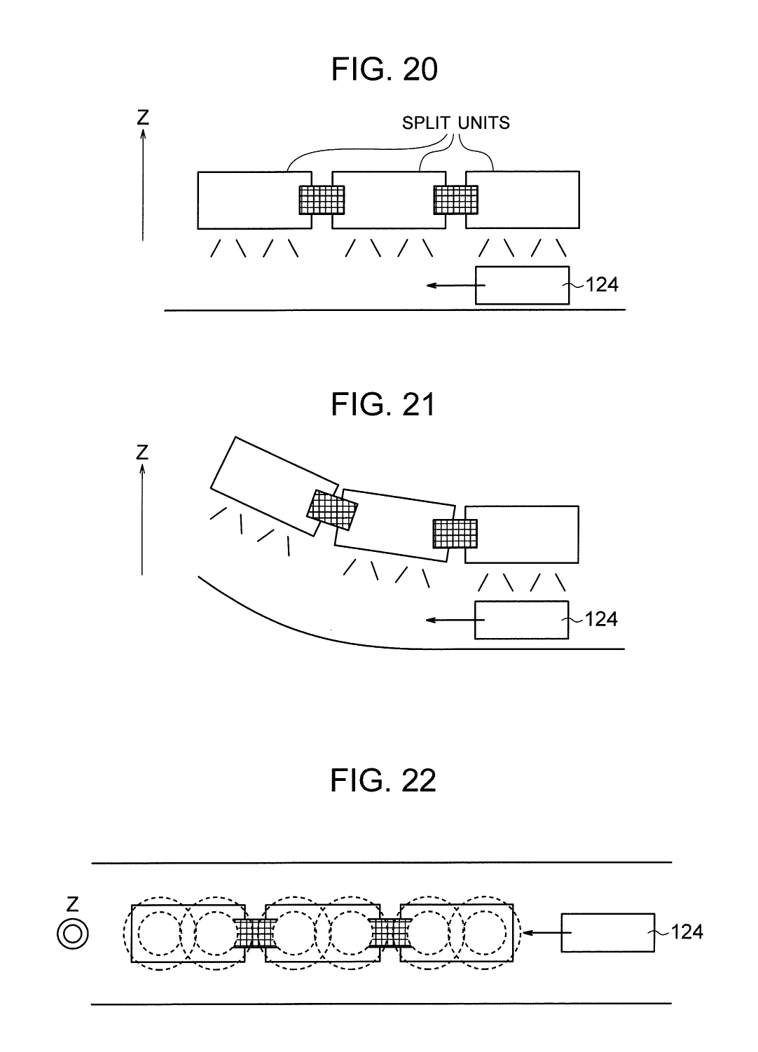

FIG. 20 shows a diagram of the unit structure of the light irradiation portion 127 of the ink curing device. The light irradiation portion is configured by three light irradiation units (hereinafter called split units). As shown in FIG. 20, the above three split units are mutually joined by a flexible hinge or the like so as to have a flexible structure which can be bent in a direction Z (direction of gravitational force) as shown in FIG. 21. Therefore, when the ink curing device is disposed at the production line, it can be disposed in conformity with the shape of the production line in direction Z.

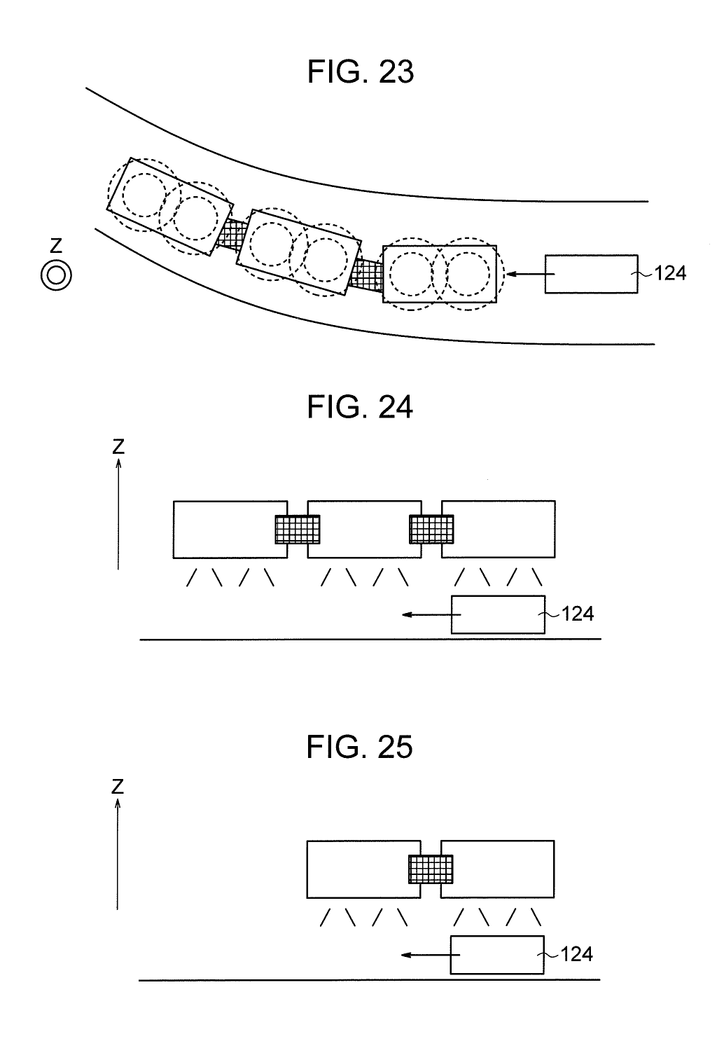

As shown in FIG. 22 and FIG. 23, the split structure can be bent horizontally different from the direction Z in FIG. 20 and FIG. 21. Thus, even if the production line is disposed in a state that it is bent in the horizontal direction, it is possible that the light irradiation portion is disposed along the shape of the conveying line and the ink is cured.

As shown in FIG. 24 and FIG. 25, the light irradiation units at the light irradiation portion of the ink curing device have a split structure and can be connected or disconnected if necessary, and the light irradiation portion can be configured of a necessary minimum number of units, so that the ink curing device can be disposed in a necessary minimum space.

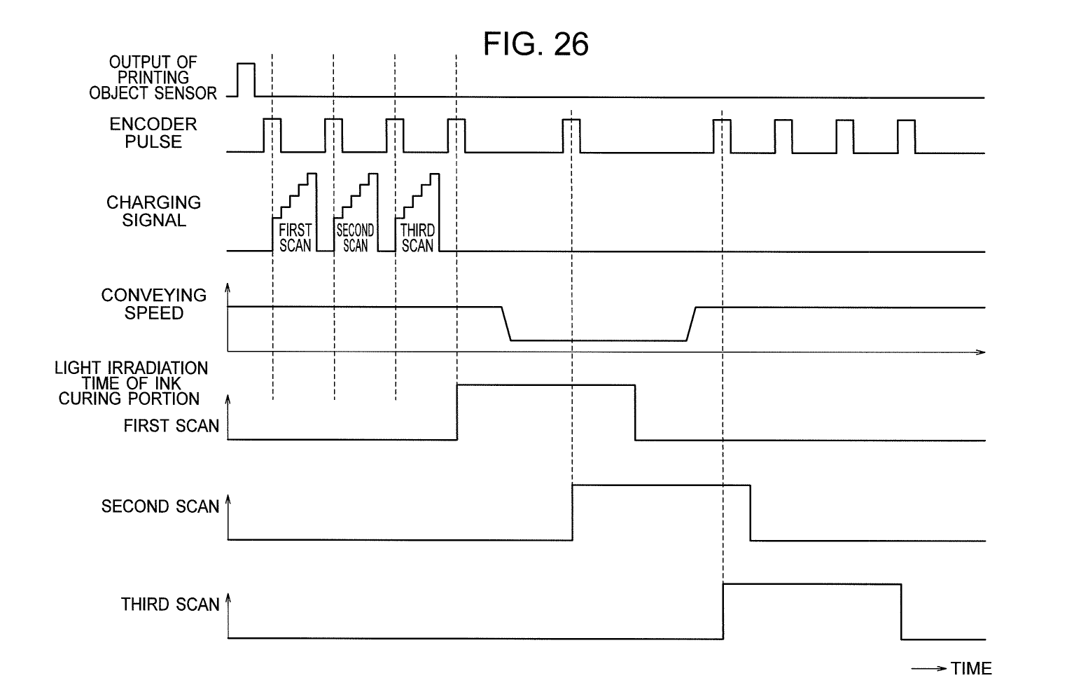

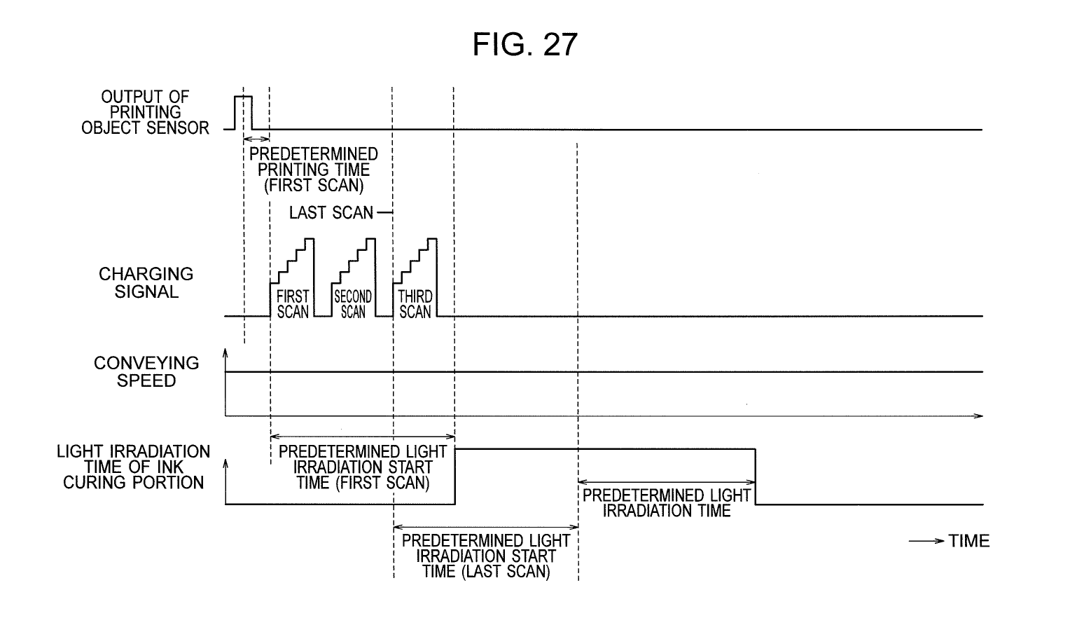

FIG. 26 shows a timing chart of a case with the speed tracking function ON.

Light irradiation of the ink curing device is started at the third scan after scanning of printing made at a predetermined pulse number. The light irradiation time determines a distance of light irradiation of the light irradiation portion based on the maximum conveying speed of the production line.

FIG. 27 shows a timing chart of a case with the speed tracking function OFF.

Timing to start the light irradiation is determined at the predetermined light irradiation timing. Light irradiation is started for printing of the first scan, and the light irradiation is continued until the last scan (the third scan in FIG. 27) is printed. Timing to stop the light irradiation comes after a lapse of the predetermined light irradiation time after the predetermined light irradiation start timing elapses after the third scan is printed.

As described above in detail, the printing system of the ink jet recording apparatus according to the present invention, after printing on the printing object, can set a target ink curing time by simply inputting the ink curing timing and ink curing time values on the operation panel, and can remedy insufficient ink curing by controlling the ink curing time depending on a change in the production line conveying speed.

Power consumption and power consumption amount are suppressed to necessary minimum by operating the ink curing device for a necessary time when it is necessary to cure the ink. And, the power consumption and power consumption amount of the ink curing device can be shown on the screen of the operation panel.

Since the ink curing device is formed to have a flexible shape, the ink curing device can be disposed in conformity with the shape of the production line.

According to the present invention, the ink curing device is disposed in conformity with the shape of the production line by forming the ink curing device to have a flexible shape, and there can be provided an ink jet recording apparatus which can reduce the power consumption and the power consumption amount by determining ink curing timing and curing the ink for necessary time.

It should be further understood by those skilled in the art that although the foregoing description has been made on embodiments of the invention, the invention is not limited thereto and various changes and modifications may be made without departing from the spirit of the invention and the scope of the appended claims.

1. An ink jet recording apparatus, comprising:
a nozzle for ejecting an ink toward a conveying track for a printing object;
a charging electrode which is disposed to electrically charge ink particles by generating a charging field in a region where the ink ejected from the nozzle is separated to become the ink particles;
deflection electrodes for deflecting the charged ink particles by generating a deflection electric field in a flying path for the ink particles;
a deflection power source for applying a deflection voltage to the deflection electrodes;
a gutter for recovering the ink particles not used for printing;
an ink curing device for curing the ink;
a rotary encoder for generating a pulse signal according to a moving speed of a production line;
a printing object detecting sensor; and
a control portion, wherein:
the control portion receives an output signal of the printing object detecting sensor, counts a pulse signal of the encoder based on a predetermined number of character scans, and controls the operation start of the ink curing device.

2. The ink jet recording apparatus according to claim 1, further comprising:
an operation panel on which printing conditions can be set and input, wherein:
the control portion controls the operation start of the ink curing device based on the number of character scans input on the operation panel.

3. The ink jet recording apparatus according to claim 2, wherein:
the operation panel can set the curing time for the ink curing device, and
the control portion controls the ink curing device based on the curing time input on the operation panel.

4. The ink jet recording apparatus according to claim 2, wherein:
the power consumption and power consumption amount of the ink curing device can be shown on the operation panel.

5. The ink jet recording apparatus according to claim 1, wherein:
the ink curing device is comprised of a plurality of units, and the units have a freely flexible hinge structure between them.

6. The ink jet recording apparatus according to claim 5, wherein:
the plurality of units of the ink curing device has a split structure that they can be connected or disconnected.
